(19) United States
(12) Patent Application Publication
(10) Pub. No.: US 2025/0174410 A1
(43) Pub. Date: May 29, 2025

(54) ELECTROLYTIC CAPACITOR AND MANUFACTURING METHOD THEREFOR

(71) Applicant: Panasonic Intellectual Property Management Co., Ltd., Osaka (JP)

(72) Inventors: Yoshikazu HIRATA, SAGA KEN (JP); Kiyoshi FURUKAWA, SAGA KEN (JP)

(21) Appl. No.: 18/841,233

(22) PCT Filed: Feb. 20, 2023
(86) PCT No.: PCT/JP2023/005926

§ 371 Date: Aug. 23, 2024

(30) Foreign Application Priority Data
Feb. 28, 2022 (JP) 2022-029173

(51) Int. Cl. H01G 9/035; H01G 9/00; H01G 9/02; H01G 9/028; H01G 9/048; H01G 9/07; H01G 9/08; H01G 9/145; H01G 9/15

(52) U.S. Cl. CPC H01G 9/035; H01G 9/0029; H01G 9/02; H01G 9/028; H01G 9/048; H01G 9/07; H01G 9/08; H01G 9/145; H01G 9/151

(57) ABSTRACT

An electrolytic capacitor includes a capacitor element and a liquid component that contains a non-aqueous solvent. The capacitor element includes an anode foil having a dielectric layer on a surface thereof, a cathode foil, and a separator and a conductive polymer component that are interposed between the anode foil and the cathode foil. The separator contains synthetic resin fibers. The water concentration in the liquid component is 1000 ppm or more and 10000 ppm or less by mass.

### TECHNICAL FIELD

The present disclosure relates to an electrolytic capacitor and a manufacturing method of the same.

### BACKGROUND ART

Solid electrolytic capacitors include a capacitor element that contains a conductive polymer component (conjugated polymer and dopant, etc.). There are also known electrolytic capacitors that include a liquid component as well as a capacitor element containing a conductive polymer component. Electrolytic capacitors containing a liquid component are considered promising because they are small in size and can provide high capacity and low equivalent series resistance (ESR). The liquid component may be a non-aqueous solvent or an electrolyte solution (solution in which a solute is dissolved in a non-aqueous solvent, etc.). The capacitor element may be a capacitor element that includes an anode foil having a dielectric layer on its surface, a cathode foil, and a separator and a conductive polymer component that are interposed between the anode foil and the cathode foil.

PTL 1 proposes a manufacturing method of a solid electrolytic capacitor that includes an anode part, a cathode part, and a conductive polymer layer, the method including a first step of forming a dielectric film on the surface of the anode part made of a sintered valve metal or a roughened valve metal foil, a second step of immersing the anode part in a dispersion containing conductive polymer particles and a solvent and applying vibrations of a frequency of 20 Hz to 500 Hz to the dispersion, and a third step of drying the anode part to form a conductive polymer layer on the surface of the dielectric film.

PTL 2 proposes an electrolytic capacitor that includes a capacitor element and an electrolyte solution, wherein the capacitor element includes an anode foil that has a dielectric layer formed thereon, a cathode foil that faces the anode foil and has a conductive layer formed thereon including a carbon layer containing conductive carbon, and a conductive polymer layer that is interposed between the anode foil and the cathode foil and contains a conductive polymer, the conductive polymer layer is formed using a dispersion or solution containing the conductive polymer, and the electrolyte solution has a water content of 0.1 to 6.0 mass %.

PTL 3 proposes a solid electrolytic capacitor in which a separator carrying a solid electrolyte is interposed between a porous anode foil having a dielectric layer formed thereon and a cathode foil, and these components are wound, wherein the solid electrolyte contains at least a conductive complex having a cationized conductive polymer and a polymer anion, and a water content of 7 mass % or less.

### CITATION LIST

### Patent Literatures

PTL 1: Japanese Laid-Open Patent Publication No. 2010-87100
PTL 2: WO 2016/174807
PTL 3: Japanese Laid-Open Patent Publication No. 2011-82313

### SUMMARY OF INVENTION

### Technical Problem

Separators using cellulose fibers are widely used in electrolytic capacitors because they are readily available and inexpensive. However, cellulose fibers are inherently relatively low in heat resistance and physical strength, and also decompose during chemical conversion, which reduces their strength inside the electrolytic capacitor. On the other hand, separators using synthetic resin fibers have higher heat resistance and strength than separators using cellulose fibers. However, if separators using synthetic resin fibers are used in electrolytic capacitors, it is difficult to obtain the effect of repairing the dielectric layer, and if a short-circuit current flows, it takes time for the conductive polymer component to become insulated and the short-circuit current to be converged, and thus sufficient short-circuit resistance performance may not be obtained.

### Solution to Problem

A first aspect of the present disclosure relates to an electrolytic capacitor including a capacitor element and a liquid component that contains a non-aqueous solvent, wherein
the capacitor element includes an anode foil having a dielectric layer on a surface thereof, a cathode foil, and a separator and a conductive polymer component that are interposed between the anode foil and the cathode foil,
the separator contains a synthetic resin fiber, and
a water concentration in the liquid component is 1000 ppm or more and 10000 ppm or less by mass.

A second aspect of the present disclosure relates to a manufacturing method of an electrolytic capacitor, including:
a step of preparing a capacitor element that includes an anode foil having a dielectric layer on a surface thereof, a cathode foil, and a separator and a conductive polymer component that are interposed between the anode foil and the cathode foil; and
a step of obtaining an electrolytic capacitor by housing in a case the capacitor element and a liquid component containing a non-aqueous solvent and having a water concentration of 1000 ppm or more and 10000 ppm or less by mass,
wherein the separator contains a synthetic resin fiber.

### Advantageous Effects of Invention

It is possible to improve the short-circuit resistance performance of an electrolytic capacitor that uses a separator containing a synthetic resin fiber.

### BRIEF DESCRIPTION OF DRAWINGS

FIG. 1 A schematic cross-sectional view of an electrolytic capacitor according to an embodiment of the present disclosure.

FIG. 2 A schematic development view of a portion of a capacitor element of the electrolytic capacitor shown in FIG. 1.

### DESCRIPTION OF EMBODIMENTS

The novel features of the present invention are set forth in the appended claims, but the present invention, both in terms of structure and content, together with other objects and features of the present invention, will be better understood from the following detailed description taken in conjunction with the drawings.

The use of a separator containing synthetic resin fibers in an electrolytic capacitor is expected to improve the separator's heat resistance, strength, and the like. However, it has become clear that when a separator containing synthetic resin fibers is used in an electrolytic capacitor containing a conductive polymer component (conjugated polymer and dopant, etc.), the short-circuit resistance performance is significantly reduced, in some cases, as compared to when a separator containing conventional cellulose fibers is used.

In an electrolytic capacitor that includes a conductive polymer component, even if a short circuit occurs internally at an early stage, the surrounding conductive polymer component is oxidatively deteriorated under heat generated by the short-circuit current, and thus the electrolytic capacitor is insulated and the short-circuit current converges. A separator containing cellulose fibers has many hydroxyl groups that can be oxygen supplies. Therefore, when a separator containing cellulose fibers is used, insulation occurs smoothly due to oxidative deterioration of the conductive polymer component as described above, and the short-circuit current can be efficiently converged at an early stage, reducing initial short-circuit failures. However, synthetic resin fibers used in separators for electrolytic capacitors have few moieties that can be oxygen supplies such as hydroxyl groups, unlike in the case of using cellulose fibers. Therefore, in electrolytic capacitors that use separators containing synthetic resin fibers, even if a short-circuit current flows, oxidative deterioration of the conductive polymer component is unlikely to progress, and it takes time for insulation to occur. In the meantime, a rush current may flow from another electrolytic capacitor connected in parallel to the short-circuited part, resulting in a short-circuit failure.

In view of the above, (1) an electrolytic capacitor according to a first aspect of the present disclosure includes a capacitor element and a liquid component containing a non-aqueous solvent. The capacitor element includes an anode foil having a dielectric layer on a surface thereof, a cathode foil, and a separator and a conductive polymer component that are interposed between the anode foil and the cathode foil. The separator contains a synthetic resin fiber. The water concentration in the liquid component is 1000 ppm or more and 10000 ppm or less by mass.

Thus, in the present disclosure, a capacitor element that includes a conductive polymer component and a separator containing a synthetic resin fiber are combined with a liquid component having a water concentration of 1000 ppm or more and 10000 ppm or less by mass. When the water concentration in the liquid component is set in such a range, first, the film repairability of the dielectric layer formed on the surface of the anode foil is enhanced, and thus leakage current is reduced and the occurrence of micro-short circuits is reduced. In addition, even if a short-circuit current flows through the capacitor element despite the use of a separator containing a synthetic resin fiber, the insulation of the conductive polymer component is promoted and the short-circuit current can be quickly converged. Therefore, it is possible to suppress flow of rush current from another capacitor element to the short-circuited site, and suppress short circuit failures at a relatively early stage. In addition, the use of a separator containing a synthetic resin fiber suppresses the deterioration of the separator and maintains high strength even if the electrolytic capacitor is used for a long period of time, as compared to the use of a separator containing a cellulose fiber. Therefore, in the present disclosure, it is also possible to suppress short-circuit failures due to separator deterioration. In this manner, the present disclosure improves the short-circuit resistance performance of an electrolytic capacitor that uses a separator containing a synthetic resin fiber.

In general, when water is contained in an electrolytic capacitor, the deterioration of the conductive polymer component is likely to progress, and a lot of gas is generated during reflow, which may apply a large pressure to the capacitor element or cause cracks in the exterior body. Therefore, it is necessary to control the content of water in the electrolytic capacitor to some extent. However, it is difficult to control the content of water in the capacitor element with high accuracy. In the present disclosure, the concentration of water in the liquid component can be adjusted, and thus the amount of water in the electrolytic capacitor can be controlled with relatively high accuracy. Therefore, it is possible to ensure high short-circuit resistance performance while keeping the gas generated during reflow to a low amount.

The concentration of water in the liquid component can be measured by a Karl Fischer water content meter using a liquid component sampled from an electrolytic capacitor. The liquid component is preferably sampled from an initial electrolytic capacitor. An initial electrolytic capacitor is an electrolytic capacitor after aging or break-in charging and discharging, or an unused electrolytic capacitor if it is a commercially available product.

(2) In the above aspect (1), a synthetic resin constituting the synthetic resin fiber may contain at least one selected from the group consisting of aromatic polyamides and polyesters.

(3) In the above aspect (1) or (2), the liquid component may contain an aprotic polar solvent at a concentration of 50 mass % or more.

(4) In the above aspect (3), the proportion of the aprotic polar solvent in the non-aqueous solvent may be 50 mass % or more.

(5) In the above aspect (3) or (4), the aprotic polar solvent may have a boiling point of 180° C. or higher.

(6) In any one of the above aspects (3) to (5), the aprotic polar solvent may contain at least one selected from the group consisting of lactone compounds, cyclic sulfone compounds, and sulfoxide compounds.

(7) In any one of the above aspects (1) to (6), the liquid component may not contain a protic organic solvent or may contain a protic organic solvent. When the liquid component contains the protic organic solvent, the concentration of the protic organic solvent in the liquid component may be 20 mass % or less.

(8) In any one of the above aspects (1) to (7), the liquid component may not contain a solute or may contain a solute. When the liquid component contains the solute, the concentration of the solute in the liquid component may be 1 mass % or less.

(9) In any one of the above aspects (1) to (8), the conductive polymer component may not contain an additive that serves as an oxygen source, or may contain an additive that serves as an oxygen source. When the conductive polymer component contains the additive, the content of the additive in the conductive polymer component may be 0.1 mass % or less.

(10) The present disclosure also includes a manufacturing method of an electrolytic capacitor. The manufacturing method of an electrolytic capacitor includes a step of preparing a capacitor element that includes an anode foil having a dielectric layer on a surface thereof, a cathode foil, and a separator and a conductive polymer component that are interposed between the anode foil and the cathode foil, and a step of obtaining an electrolytic capacitor by housing in a case the capacitor element and a liquid component containing a non-aqueous solvent and having a water concentration of 1000 ppm or more and 10000 ppm or less by mass. The separator contains a synthetic resin fiber.

(11) In the above aspect (10), in the step of preparing the capacitor element, the capacitor element may be prepared by impregnating a precursor including the anode foil, the cathode foil, and the separator into a treatment liquid containing the conductive polymer component, and drying the precursor.

(12) In the above aspect (11), the treatment liquid may not contain an additive that serves as an oxygen source, or may contain an additive that serves as an oxygen source. When the treatment liquid contains the additive, the content of the additive in the treatment liquid may be 15 mass % or less.

The electrolytic capacitor and the manufacturing method of the same according to the present disclosure will be described in more detail below, including the above aspects (1) to (12). At least one of the above aspects (1) to (12) may be combined with at least one of the elements described below, provided that there is no technical contradiction.

### [Electrolytic Capacitor]

### (Capacitor Element)

The capacitor element included in the electrolytic capacitor includes an anode foil having a dielectric layer on its surface, a cathode foil, and a separator and a conductive polymer component that are interposed therebetween.

### (Anode Foil)

The anode foil may contain a valve metal, an alloy containing a valve metal, a compound containing a valve metal, or the like. These materials may be used alone or may be used in combination of two or more. The valve metal is preferably aluminum, tantalum, niobium, or titanium, for example.

The anode foil may have a porous part with pores at the surface layer. The anode foil having the porous part can be obtained by roughening the surface of a base material (foil-shaped or plate-shaped base material, etc.) containing a valve metal, for example. The roughening can be performed by etching (e.g., electrolytic etching or chemical etching).

### (Dielectric Layer)

The dielectric layer is formed by anodizing the valve metal at the surface of the anode foil. The anodization is performed by chemical conversion treatment or the like, for example. The dielectric layer is formed so as to cover at least the surface of a portion of the anode foil, for example.

The dielectric layer contains an oxide of a valve metal. For example, when tantalum is used as the valve metal, the dielectric layer contains Ta₂O₅, and when aluminum is used as the valve metal, the dielectric layer contains Al₂O₃. However, the dielectric layer is not limited thereto and may be made of any material that functions as a dielectric.

The dielectric layer is usually formed on the surface of the anode foil. When the dielectric layer is formed on the surface of the porous part of the anode foil, the dielectric layer is formed along the inner wall surfaces of the pores in the porous part and the depressions (pits) on the surface of the anode foil.

### (Conductive Polymer Component)

The conductive polymer component contains a conjugated polymer and a dopant, for example. The conductive polymer component is interposed between the anode foil and the cathode foil. The conductive polymer component may be impregnated into a separator that is interposed between the anode foil and the cathode foil. The conductive polymer component may be in contact with at least a portion of the dielectric layer and at least a portion of the cathode foil. The conductive polymer component may constitute a layer. The conductive polymer component is also called solid electrolyte. The conductive polymer component constitutes at least a portion of the cathode body in the electrolytic capacitor. The conductive polymer component may further contain an additive, as necessary.

### (Conjugated Polymer)

The conjugated polymer may be a known conjugated polymer used in an electrolytic capacitor, such as a x-conjugated polymer. Examples of the conjugated polymer include polymers having a basic skeleton of polypyrrole, polythiophene, polyaniline, polyfuran, polyacetylene, polyphenylene, polyphenylenevinylene, polyacene, and polythiophenevinylene. The above polymers may contain at least one monomer unit constituting the basic skeleton. The above polymers may also include a homopolymer, a copolymer of two or more monomers, and derivatives thereof (substituted product having a substituent, etc.). For example, polythiophene also includes poly(3,4-ethylenedioxythiophene) (PEDOT).

One conjugated polymer may be used alone, or two or more conjugated polymers may be used in combination.

The weight-average molecular weight (Mw) of the conjugated polymer is not particularly limited, and is 1,000 or more and 1,000,000 or less, for example.

The weight-average molecular weight (Mw) here takes a value measured in terms of polystyrene by gel permeation chromatography (GPC). The GPC is usually used with a polystyrene gel column and water/methanol (volume ratio 8/2) as a mobile phase.

### (Dopant)

The dopant may be a relatively low-molecular anion, a polymer anion, or the like. Examples of the anion include sulfate ion, nitrate ion, phosphate ion, borate ion, organic sulfonate ion, and carboxylate ion. Compounds that generate these anions are used as dopants. Examples of dopants that generate sulfonate ions include paratoluenesulfonic acid and naphthalenesulfonic acid.

Examples of the polymer anion include polyvinyl sulfonic acid, polystyrene sulfonic acid (PSS), polyallyl sulfonic acid, polyacrylic sulfonic acid, polymethacrylic sulfonic acid, poly(2-acrylamido-2-methylpropane sulfonic acid), polyisoprene sulfonic acid, polyester sulfonic acid (aromatic polyester sulfonic acid, etc.), phenolsulfonic acid novolac resin, and polyacrylic acid. The polymeric anion may be a polymer of a single monomer, a copolymer of two or more monomers, or a substituted product having a substituent. Of these, a polyanion derived from polystyrene sulfonic acid is preferable. However, these dopants are merely examples, and the present disclosure is not limited thereto. Dopants may be used alone, or may be used in combination of two or more.

The conductive polymer component may be formed by performing at least one of chemical polymerization and electrolytic polymerization of a precursor of a conjugated polymer on the dielectric layer in the presence of a dopant, for example. Alternatively, the conductive polymer component may be formed by bringing a solution in which the conductive polymer component is dissolved or a dispersion in which the conductive polymer component is dispersed, into contact with the dielectric layer. The conductive polymer component used in such a solution or dispersion can be obtained by polymerizing a precursor of a conjugated polymer in the presence of a dopant. Examples of the precursor of a conjugated polymer include raw material monomers of a conjugated polymer, and oligomers and prepolymers in which a plurality of molecular chains of raw material monomers are linked together. Precursors may be used alone, or may be used in combination of two or more.

The amount of dopant contained in the conductive polymer component is 10 parts by mass or more and 1000 parts by mass or less, for example, and may be 20 parts by mass or more and 500 parts by mass or less, relative to 100 parts by mass of the conjugated polymer.

The conductive polymer component may contain an additive that serves as an oxygen source. Examples of the additive include polyhydric alcohols (alkylene glycols, glycerin, polyglycerin, sugar alcohols, etc.) or alkylene oxide adducts thereof (C₂₋₄ alkylene oxide adducts such as ethylene oxide adducts and polyethylene oxide adducts), and polyalkylene glycols (polyethylene glycol, polypropylene glycol, oxyethylene-oxypropylene copolymers, etc.). The conductive polymer component may contain one of these additives or a combination of two or more thereof.

The additives as described above can enhance the film repairability of the dielectric layer and can promote the oxidative deterioration of the conductive polymer component if a short-circuit current flows. In the present disclosure, since the water concentration in the liquid component is set within a specific range, it is possible to ensure high film repairability of the dielectric layer and excellent short-circuit resistance performance, even if the conductive polymer component does not contain such an additive or contains a low content of additive.

The additive is used in a relatively large proportion relative to the total amount of conjugated polymer and dopant. For example, the additive may be used in an amount of 1000 to 1200 parts by mass relative to 100 parts by mass of the conjugated polymer and the dopant in total. When the conductive polymer component contains the additive, the content of the additive in the conductive polymer component may be 30% by mass or less, may be 15% by mass or less or 10% by mass or less, or may be 5% by mass or less, for example. It is also preferable that the conductive polymer component does not contain the additive. In this case, the trace of the additive in the conductive polymer component may be below the detection limit.

### (Cathode Foil)

The cathode foil is constituted of a metal foil. The type of metal is not particularly limited, but it is preferable to use a valve metal such as aluminum, tantalum, and niobium, or an alloy containing a valve metal. If necessary, the surface of the metal foil may be roughened. The surface of the metal foil may be provided with a chemical conversion film, or may be provided with a coating of a metal (dissimilar metal) different from the metal constituting the metal foil or a coating of a nonmetal. Examples of the dissimilar metal or nonmetal include metals such as titanium and nonmetals such as carbon.

### (Separator)

The separator contains a synthetic resin fiber(s). The separator may be a nonwoven fabric containing a synthetic resin fiber(s), or a laminate body containing a nonwoven fabric of a synthetic resin fiber(s). The nonwoven fabric containing a synthetic resin fiber(s) is preferably a nonwoven fabric made of a synthetic resin fiber(s). The separator may contain known additives used in separator formation as necessary.

The synthetic resin constituting the fiber may be at least one resin (first resin) selected from the group consisting of polyesters and polyamides (aliphatic polyamide, aromatic polyamide, etc.), from the viewpoint of excellent strength or heat resistance. From the viewpoint of obtaining higher strength or heat resistance, polyesters (aromatic polyester, etc.), aromatic polyamide, and the like are preferable. These synthetic resins have high initial strength and are less likely to deteriorate as compared to cellulose. However, these synthetic resins have poor film repairability of the dielectric layer, and are unlikely to insulate the conductive polymer component even if a short-circuit current flows, and thus the short-circuit current has difficulty converging. In the present disclosure, even when a separator containing such a synthetic resin is used, the liquid component has a specific water concentration, and thus the film repairability of the dielectric layer can be improved and the insulation of the conductive polymer component can be promoted by the short-circuit current. In addition, the deterioration of the separator itself is suppressed, and thus the risk of a short-circuit failure during long-term use can be reduced.

The aromatic polyester may be a polyalkylene arylate such as a polyethylene terephthalate (e.g., poly(C₂₋₄alkylene-C₆₋₁₀arylate)) or the like. The aromatic polyamide may be a wholly aromatic polyamide such as aramid. The synthetic resin fibers may contain one type of first resin or a combination of two or more types of first resin.

The synthetic resin fiber may contain a resin (second resin) other than the first resin. Examples of the second resin include cellulose or derivatives thereof (regenerated cellulose, cellulose ether, cellulose ester, etc.), vinylon, polyurethane, acrylic resin, and polyolefin. However, these materials are relatively low in strength or heat resistance. In addition, some of these materials contain a large amount of hydroxyl groups that serve as oxygen supplies, such as cellulose and vinylon. Therefore, in the electrolytic capacitor of the present disclosure, the content of the second resin in the separator is preferably low. It is also preferable that the separator does not contain the second resin. In the present disclosure, even if the separator does not contain cellulose fibers or vinylon fibers, excellent short-circuit resistance performance can be ensured. The proportion of the first resin in the separator is preferably 80% by mass or more, and may be 90% by mass or more. The proportion of the first resin in the separator is 100% by mass or less. The fibers constituting the separator may be constituted only of fibers made of the first resin.

### (Related Matters)

The electrolytic capacitor may be a wound type, or may be either a chip type or a laminated type. The electrolytic capacitor has at least one capacitor element. The electrolytic capacitor may have a plurality of capacitor elements. For example, the electrolytic capacitor may have a stacked body of two or more capacitor elements, or may have two or more wound-type capacitor elements. The configuration or number of the capacitor element(s) may be selected according to the type or use application of the electrolytic capacitor.

### (Liquid Component)

The liquid component contains a non-aqueous solvent. The liquid component may further contain a solute (electrolyte).

### (Water)

In the electrolytic capacitor of the present disclosure, the concentration of water in the liquid component is 1000 ppm or more and 10000 ppm or less by mass. When the water concentration is in such a range, it is possible to improve the short-circuit resistance performance of an electrolytic capacitor that uses a separator containing synthetic resin fibers, as described above. The concentration of water in the liquid component may be 2000 ppm or more and 5000 ppm or less by mass. When the water concentration is in such a range, it is possible to obtain a higher film repairability of the dielectric layer and further reduce the amount of gas generated during reflow. From the viewpoint of ensuring a higher short-circuit resistance performance, the concentration of water in the liquid component may be 3000 ppm or more and 10000 ppm or less by mass. From the viewpoint of keeping the amount of gas generated during reflow to a lower level, the concentration of water in the liquid component may be 1000 ppm or more and 5000 ppm or less, or 1500 ppm or more and 4000 ppm or less by mass. If water is contained in the components (capacitor element, etc.) of the electrolytic capacitor other than the liquid component, this water may seep into the liquid component. If water is contained in the capacitor element or the like, the concentration of water in the liquid component is set within the above-described range in consideration of the seepage of the water into the liquid component, and thus it is possible to ensure advantageous effects such as achieving high short-circuit resistance performance and reducing the amount of gas generated during reflow.

### (Non-aqueous Solvent)

The non-aqueous solvent is at least a polar solvent. The non-aqueous solvent may include a polar solvent and a non-polar solvent. Examples of the non-aqueous solvent include a sulfone compound, a lactone compound, a carbonate compound, and an alcohol compound. The liquid component may contain one type of non-aqueous solvent, or may contain a combination of two or more types of non-aqueous solvents.

The liquid component preferably contains an aprotic polar solvent. Among the above-mentioned non-aqueous solvents, the aprotic polar solvent may be a non-aqueous solvent other than an alcohol compound, specifically a sulfone compound, a lactone compound, or a carbonate compound. The liquid component may contain one type of aprotic polar solvent, or may contain a combination of two or more types of aprotic polar solvents. As compared with protic polar solvents such as alcohol compounds, aprotic polar solvents have a low film repairability of the dielectric layer and few oxygen supplies such as hydroxyl groups that oxidatively deteriorate the conductive polymer component, and are thus inferior in the ability to insulate the conductive polymer component when a short-circuit current flows. In the present disclosure, even when such an aprotic polar solvent is used as the liquid component, setting the concentration of water in the liquid component to a specific range makes it possible to obtain high film repairability of the dielectric layer and promote the insulation of the conductive polymer component even if a short-circuit current flows, and thus high short-circuit resistance performance can be ensured. Even if the concentration of the aprotic polar solvent in the liquid component is high, excellent short-circuit resistance performance can be ensured.

The concentration of the aprotic polar solvent in the liquid component may be 50% by mass or more, may be 70% by mass or more, or may be 80% by mass or more. In the present disclosure, even if the concentration of the aprotic polar solvent is so high, excellent short-circuit resistance performance can be ensured.

The proportion of the aprotic polar solvent in the non-aqueous solvent contained in the liquid component may be 50% by mass or more, may be more than 67% by mass, may be 70% by mass or more, may be 80% by mass or more, or may be 90% by mass or more. In the present disclosure, even if the proportion of the aprotic polar solvent in the non-aqueous solvent is high, excellent short-circuit resistance performance can be ensured. The proportion of the aprotic polar solvent in the non-aqueous solvent is 100% by mass or less. The non-aqueous solvent may be constituted of the aprotic polar solvent alone.

Among the aprotic polar solvents, examples of the sulfone compounds include cyclic sulfone compounds (sulfolane (SL), etc.), sulfoxide compounds (dimethyl sulfoxide, diethyl sulfoxide, etc.). Examples of the lactone compounds include γ-butyrolactone (GBL) and γ-valerolactone. Examples of the carbonate compounds include chain carbonates (dimethyl carbonate, diethyl carbonate, ethyl methyl carbonate, etc.), and cyclic carbonates (ethylene carbonate, propylene carbonate, fluoroethylene carbonate, etc.). Among these, sulfone compounds and lactone compounds are preferred from the viewpoint of obtaining high ionic conductivity and easily obtaining excellent capacitor performance (e.g., low ESR and high capacity). These aprotic polar solvents may be used alone or in combination of two or more.

The boiling point of the aprotic polar solvent may be 180° C. or higher, or may be 200° C. or higher. In this case, gas generation during reflow can be reduced. Since evaporation of the liquid component is reduced, the durability of the electrolytic capacitor can be improved. The aprotic polar solvent having such a boiling point is preferably at least one selected from the group consisting of lactone compounds, cyclic sulfone compounds, and sulfoxide compounds (dimethyl sulfoxide, etc.).

Among the non-aqueous solvents, alcohol compounds that are protic polar solvents include monohydric alcohols and polyhydric alcohols. Examples of polyhydric alcohols include glycol compounds (alkylene glycols (ethylene glycol, propylene glycol, etc.), and polyalkylene glycols (polyethylene glycol, polypropylene glycol, etc.)), glycerin compounds (glycerin, polyglycerin, etc.), sugar alcohol compounds, and alkylene oxide adducts thereof (ethylene oxide adducts, polyethylene oxide adducts, etc.). Alcohol compounds are protic organic solvents having hydroxyl groups. Since alcohol compounds have hydroxyl groups, the film repairability of the dielectric layer is relatively high. Even when a separator containing synthetic resin fibers is used, the hydroxyl group can be an oxygen source for insulating the conductive polymer component by oxidative degradation if a short-circuit current flows.

In the present disclosure, a liquid component containing water at a specific concentration is used. Accordingly, even if the liquid component (or non-aqueous solvent) does not contain a protic organic solvent (alcohol compound, etc.) or has a low content of protic organic solvent, it is possible to obtain high film repairability of the dielectric layer and ensure excellent short-circuit resistance performance.

Therefore, the liquid component may not contain a protic organic solvent. When the liquid component contains a protic organic solvent, the concentration of the protic organic solvent in the liquid component may be 50% by mass or less or 30% by mass or less, may be 20% by mass or less or 10% by mass or less, may be less than 3% by mass, may be 2% by mass or less or 1% by mass or less.

### (Solute)

The liquid component may contain a solute (electrolyte). Examples of the solute include an acid component and a base component.

Examples of the acid component include aromatic carboxylic acids (particularly aromatic hydroxy acids (benzoic acid, salicylic acid, etc.), and aromatic polycarboxylic acids (phthalic acid, pyromellitic acid, etc.)). The acid component may be a borodisalicylic acid, borodisalic acid, borodiglycolic acid, borodigallic acid, borodicatechol, borodipyrogallol, or the like. However, the acid component is not limited thereto. The liquid component may contain one type of acid component, or may contain two or more types of acid components.

The acid component may be contained in the liquid component in a free form, in an anionic form, or in a hydrochloric form. All of these forms will be called acid components.

The liquid component may contain a base component together with the acid component. Examples of the base component include ammonia, amines (specifically, primary amines, secondary amines, and tertiary amines), quaternary ammonium compounds, and amidinium compounds. The liquid component may contain one type of base component, or may contain two or more types of base components.

The amine may be any of aliphatic, aromatic, and heterocyclic. Examples of the amine include trimethylamine, diethylamine, ethyldimethylamine, triethylamine, ethylenediamine, aniline, pyrrolidine, imidazole (1,2,3,4-tetramethylimidazolinium, etc.), and 4-dimethylaminopyridine. Examples of the quaternary ammonium compound include amidine compounds (including imidazole compounds).

The liquid component may contain the base component in a free form, in a cationic form, or in a hydrochloric form. All of these forms will be called base components.

When the liquid component contains a solute, the film repairability of the dielectric layer is increased and the conductive polymer component is easily insulated if a short-circuit current flows. However, in the present disclosure, since the liquid component contains water at a specific concentration, it is possible to ensure high film repairability of the dielectric layer and high short-circuit resistance performance even if the liquid component does not contain a solute or contains a low concentration of solute.

When the liquid component contains a solute, the concentration of the solute in the liquid component may be 1% by mass or less, or may be 0.1% by mass or less. It is also preferable that the liquid component does not contain a solute. In this case, the trace of the solute in the liquid component may be below the detection limit. The concentration of the solute is the sum of the acid component and the base component. The concentration of the acid component is calculated for free acid, not anionic or hydrochloric acid. Similarly, the concentration of the base component is calculated for free base, not cationic or hydrochloric base.

The components contained in the liquid component can be identified by infrared absorption spectroscopy, ultraviolet-visible absorption spectroscopy, gas chromatograph mass spectrometry, liquid chromatograph mass spectrometry, magnetic resonance spectroscopy, or the like, using the liquid component collected from the electrolytic capacitor. The liquid component is preferably collected from an initial electrolytic capacitor. The initial electrolytic capacitor is an electrolytic capacitor after break-in charging and discharging, or an unused electrolytic capacitor if it is a commercially available product. The quantitative analysis of the components contained in the liquid component can be performed by using a calibration curve method or the like in the above-described analysis method.

### (Related Matters)

The electrolytic capacitor is manufactured by a manufacturing method including a step of preparing a capacitor element (first step) and a step of obtaining an electrolytic capacitor by housing the capacitor element and the liquid component in a case (third step), for example. The liquid component housed in the case contains a non-aqueous solvent and has a water concentration in the above range. The manufacturing method of the electrolytic capacitor usually includes a step of preparing the liquid component (second step) prior to the third step.

### (First Step)

A capacitor element that includes an anode foil having a dielectric layer on a surface thereof, a cathode foil, and a separator and a conductive polymer component interposed between the anode foil and the cathode foil is prepared. The separator contains a synthetic resin fiber(s) as described above. Each component of the electrolytic capacitor can be prepared with reference to the description of each component.

In the first step, a capacitor element may be prepared by impregnating a precursor including an anode foil, a cathode foil, and a separator with a treatment liquid containing a conductive polymer component, and then drying the precursor, for example. The precursor may be a wound body or a laminated body that includes an anode foil, a cathode foil, and a separator interposed therebetween.

The treatment liquid may be a polymerization liquid for chemical polymerization or electrolytic polymerization, a solution in which a conductive polymer component is dissolved (or a dispersion liquid in which a conductive polymer component is dispersed), or the like, as described above. From the viewpoints of easily interposing the conductive polymer component between the anode foil and the cathode foil and reducing the inclusion of additives or unreacted components during polymerization, it is preferable to use a solution or dispersion liquid containing a conductive polymer component, as the treatment liquid.

The treatment liquid may contain an oxidizing agent as necessary. However, in the present disclosure, as described above, even if the treatment liquid does not contain an additive that serves as an oxygen supply or contains a low content of an additive that serves as an oxygen supply, the liquid component contains a specific concentration of water, and thus the high film repairability of the dielectric layer can be ensured and excellent short-circuit resistance performance can be ensured. When the treatment liquid contains an additive that serves as an oxygen supply, the content of the additive in the treatment liquid may be 0.1 mass % or less, or may be 0.01 mass % or less. It is also preferable that the treatment liquid does not contain such an additive. In this case, the trace of the additive that serves as an oxygen supply in the treatment liquid may be below the detection limit.

The capacitor element is in a dried state prior to being housed in the case. Therefore, the water content of the capacitor element before being housed in the case is low. The water content of the capacitor element before being housed in the case may be 5000 ppm or less or 1000 ppm or less, may be 500 ppm or less, or may be 300 ppm or less, by mass, for example. When the water content of the capacitor element before being housed/stored in the case is within such a range, the water content of the electrolytic capacitor element can be precisely adjusted by the liquid component, and thus high short-circuit resistance performance can be ensured while keeping the amount of gas generated during reflow to a low level. The water content of the capacitor element is the mass ratio of water when the capacitor element (excluding the water) is taken as 100 mass %. Even if the capacitor element contains a certain amount of water, taking into account the amount of water seeping out from the capacitor element into the liquid component and setting the amount of water contained in the liquid component to 1,000 ppm or more and 10,000 ppm or less makes it possible to enhance the short-circuit resistance performance while keeping the amount of gas generated during reflow to a low level, even if the separator contains synthetic resin fibers.

In the capacitor element, one end of a cathode lead terminal is electrically connected to the cathode foil. One end of an anode lead terminal is electrically connected to the anode foil. Each lead terminal may be joined to an electrode (metal foil, etc.) by welding or the like, or may be joined to the electrode via a conductive adhesive, for example.

### (Second Step)

In the second step, a liquid component containing a non-aqueous solvent and having a water concentration in the above-described specific range is prepared. The liquid component may be prepared by mixing components (non-aqueous solvent and water, electrolyte, additives, and the like as necessary), for example. For example, the water concentration is adjusted by regulating the mixing ratio of the components.

### (Third Step)

In the third step, the capacitor element prepared in the first step and the liquid component prepared in the second step are housed in a case. After the housing, the opening of the case is sealed to obtain an electrolytic capacitor. The sealing can be performed by a known method depending on the shape of the case. For example, the electrolytic capacitor may be formed by storing the capacitor element and the liquid component in a bottomed case and sealing the opening of the bottomed case with a sealing member. At this time, the other end of the anode lead terminal and the other end of the cathode lead terminal are each lead out from the case. The other end of each terminal exposed from the case is used for solder connection with a substrate on which the electrolytic capacitor is to be mounted.

The electrolytic capacitor of the present disclosure will be described in more detail below with reference to embodiments. However, the electrolytic capacitor of the present disclosure is not limited to only the following embodiments.

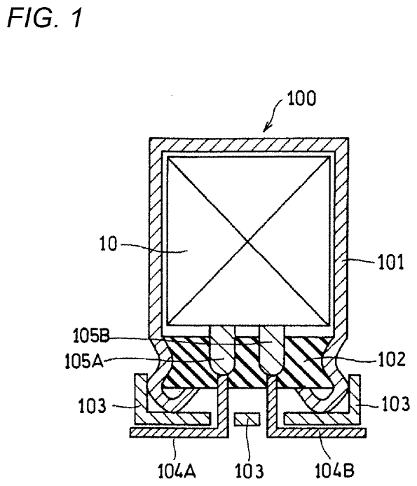

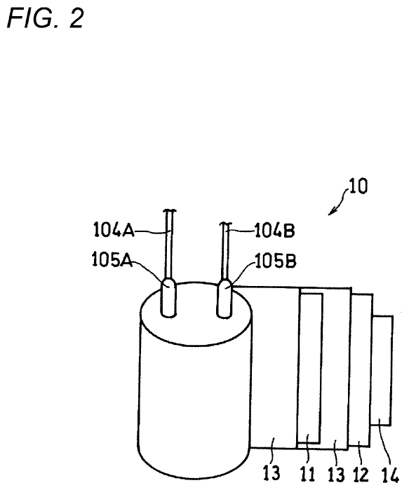

FIG. 1 is a schematic cross-sectional view of an electrolytic capacitor according to the present embodiment, and FIG. 2 is a schematic development view of a portion of a capacitor element in the electrolytic capacitor.

The electrolytic capacitor includes a capacitor element 10, a bottomed case 101 that houses the capacitor element 10 and a liquid component not shown, a sealing member 102 that closes the opening of the bottomed case 101, a seat plate 103 that covers the sealing member 102, lead wires 104A and 104B that are led out from the sealing member 102 and pass through the seat plate 103, and lead tabs 105A and 105B that connect the lead wires to electrodes of the capacitor element 10, for example. The vicinity of the open end of the bottomed case 101 is drawn inward, and the open end is curled so as to be crimped to the sealing member 102.

The capacitor element 10 is a wound body as shown in FIG. 2, for example. The wound body includes an anode foil 11 connected to the lead tab 105A, a cathode foil 12 connected to the lead tab 105B, and a separator 13. The anode foil 11 and the cathode foil 12 are wound with the separator 13 interposed therebetween. The outermost periphery of the wound body is fixed by fixing tape 14. FIG. 2 shows the wound body in a partially unwound state before the outermost periphery is fixed.

In the capacitor element 10, a dielectric layer not shown is formed on at least the surface of a portion of the anode foil 11. The separator 13 and a conductive polymer component not shown are interposed between the anode foil 11 and the cathode foil 12. The conductive polymer component is in contact with at least a portion of the dielectric layer. The conductive polymer component is also in contact with at least a portion of the cathode foil 12. The conductive polymer component and the separator are impregnated with a liquid component.

### EXAMPLES

The present invention will be specifically described below with reference to examples and comparative examples, but the present invention is not limited to the following examples.

<Electrolytic Capacitors E1 to E3 and C1 to C2>

Wound-type electrolytic capacitors (diameter: 10 mm×length: 12 mm) were fabricated by the following procedure.

### (Preparation of Anode Foil)

An aluminum foil (thickness: 100 μm) whose surface was roughened by etching was subjected to chemical conversion treatment. Specifically, the aluminum foil was anodized at 150 V in an aqueous solution of ammonium adipate (concentration: 2%). In this manner, a dielectric layer was formed on the surface of the aluminum foil to obtain an anode foil.

### (Preparation of Cathode Foil)

An aluminum foil (thickness: 50 μm) whose surface was roughened by etching was subjected to chemical conversion treatment. Specifically, the aluminum foil was anodized at 3 V in an aqueous solution of ammonium adipate (concentration: 2%). In this manner, a dielectric layer was formed on the surface of the aluminum foil to obtain a cathode foil.

### (Preparation of Wound Body)

An anode lead tab and a cathode lead tab connected to lead wires were connected to the prepared anode foil and cathode foil, respectively. The anode foil and the cathode foil were then wound with a separator therebetween, and the outer surface was fixed with fixing tape. In this manner, a wound body (diameter: 8.5 mm and height: 7.0 mm) was prepared as an electrode group. A nonwoven fabric of aramid fibers (thickness: 40 μm) was used as the separator.

### (Preparation of Treatment Liquid Containing Conductive Polymer)

The following treatment liquid A was prepared as a treatment liquid containing a conductive polymer.
Treatment liquid A: PEDOT/PSS aqueous dispersion liquid (concentration: 2% by mass)

The PEDOT/PSS refers to PEDOT doped with PSS.

### (Formation of Conductive Polymer Component)

The wound body was immersed once in the treatment liquid A and dried. Then, the treatment liquid A was dropped onto the wound body using a dispenser, and the wound body was left in a reduced pressure atmosphere for five minutes. Next, the wound body was dried at 150° C. for 30 minutes in an atmospheric pressure atmosphere. In this manner, a capacitor element was obtained in which the conductive polymer component was interposed between the anode foil and cathode foil of the wound body. The water content of the capacitor element after drying was 288 ppm.

### (Preparation of Liquid Component)

GBL and SL were mixed at a mass ratio of GBL: SL=50:50. Water was added to the mixed solvent to prepare a liquid component. The amount of water added and the water concentration in the GBL or SL used were adjusted such that the water concentration in the liquid component obtained by the above-described procedure reached the value shown in Table 1.

### (Assembly of Electrolytic Capacitors)

The capacitor element and the liquid component were housed in an aluminum bottomed case (thickness: 0.3 mm), and the opening of the bottomed case was sealed by placing a rubber sealing member and a seat plate. The bottomed case was subjected to aging treatment at 130° C. for two hours while the rated voltage was applied. In this manner, a total of 100 electrolytic capacitors were obtained in each example.

### (Evaluation)

(a) Exterior Expansion Rate under Reflow Treatment

The electrolytic capacitor fabricated as described above was subjected to a heat load under conditions simulating the reflow treatment. Specifically, the electrolytic capacitor was heated at 230° C. or higher with a peak temperature of 250° C. for 40 seconds, and then heated at 200° C. or higher for 60 seconds, and this profile was performed twice in total. The height from the outer bottom surface of the bottomed case to the outer surface of the sealing member (height from the upper surface of the case 101 to the lower surface of the sealing member 102 in FIG. 1) was measured in the electrolytic capacitor before and after reflow treatment, and the amount of change in height under the reflow treatment was calculated. The ratio (%) of the amount of change in height was calculated where the height before the reflow treatment was set to 100%. The average value of the ratios of change in height of the 100 electrolytic capacitors was calculated and evaluated as the exterior expansion rate under the reflow treatment.

### (b) Short-circuit Occurrence Rate

A voltage of 96 V, which was 1.2 times the rated voltage, was applied to the electrolytic capacitors to which a thermal load was applied under conditions simulating the reflow treatment in the above (a) for 500 hours in an environment at 150° C. During this process, electrolytic capacitors that generated a leakage current of 20 mA or more were considered to be short-circuited, and the number of electrolytic capacitors that were short-circuited within 500 hours was totaled. The proportion (%) of the number of short-circuited electrolytic capacitors of the 100 electrolytic capacitors was calculated as the short-circuit occurrence rate (%).

Table 1 shows the evaluation results. In Table 1, E1 to E3 indicate examples, and C1 to C2 indicate comparative examples. The values of water concentration in Table 1 are the average values obtained after aging five electrolytic capacitor samples in each example that were fabricated in the same manner as the electrolytic capacitors E1 to E3 and C1 to C2. More specifically, after aging the samples, the liquid components were extracted from the samples and the water concentration was measured using a Karl Fischer moisture meter, and the average value of the five samples was obtained.

TABLE 1

| | Water concentration | | Exterior expansion |
|---|---|---|---|
| | (mass ppm) | Short-circuit | rate under reflow |
| Sample | (in liquid component) | occurrence rate | treatment |
| E1 | 1540 | 3% | 0.30% |
| E2 | 3450 | 1% | 0.39% |
| E3 | 9480 | 0% | 1.03% |
| C1 | 360 | 18% | 0.28% |
| C2 | 24800 | 0% | 3.41% |

As shown in Table 1, in C1, the water concentration in the liquid component is low, and thus the exterior expansion rate under reflow is kept low, but the short-circuit occurrence rate is as high at 18%. In C2, the water concentration is high and the short circuit occurrence rate is 0%, but the exterior expansion rate under reflow is high. As above, when the liquid component contains a lot of water, internal short circuits can be suppressed, but the amount of gas generated during reflow is large. If the amount of gas generated during reflow is large, the exterior may expand as in C2. If the exterior cannot absorb stress, the stress may be applied to the capacitor element, causing a decrease in capacitor performance. In contrast, in E1 to E3, the water concentration in the liquid component is within a specific range, and thus the exterior expansion rate under reflow in the liquid component can be kept low while the short-circuit occurrence rate can also be kept low.

Although the present invention has been described with reference to the presently preferred embodiments, the disclosure should not be interpreted as limiting. Various variations and modifications will no doubt become apparent to those skilled in the art to which the present invention pertains upon reading the above disclosure. Therefore, the appended claims should be interpreted to cover all variations and modifications without departing from the true spirit and scope of the present invention.

### INDUSTRIAL APPLICABILITY

The electrolytic capacitor of the present disclosure has excellent short-circuit resistance performance and reduces short-circuit failures at an early stage and after long-term use. Therefore, the electrolytic capacitor is particularly suitable for use applications requiring high reliability. However, the use applications of the electrolytic capacitor are not limited thereto.

### REFERENCE SIGNS LIST

100: electrolytic capacitor, 01: bottomed case, 102: sealing member, 103: seat plate, 104a, 104b: lead wire, 105a, 105b: lead tab, 10: capacitor element, 11: anode foil, 12: cathode foil, 13: separator, 14: fixing tape

1. An electrolytic capacitor comprising a capacitor element and a liquid component that contains a non-aqueous solvent, wherein
the capacitor element includes an anode foil having a dielectric layer on a surface thereof, a cathode foil, and a separator and a conductive polymer component that are interposed between the anode foil and the cathode foil,
the separator contains a synthetic resin fiber, and
a water concentration in the liquid component is 1000 ppm or more and 10000 ppm or less by mass.

2. The electrolytic capacitor according to claim 1, wherein a synthetic resin constituting the synthetic resin fiber contains at least one selected from the group consisting of aromatic polyamides and polyesters.

3. The electrolytic capacitor according to claim 1, wherein the liquid component contains an aprotic polar solvent at a concentration of 50 mass % or more.

4. The electrolytic capacitor according to claim 3, wherein a proportion of the aprotic polar solvent in the non-aqueous solvent is 50 mass % or more.

5. The electrolytic capacitor according to claim 3, wherein the aprotic polar solvent has a boiling point of 180° C. or higher.

6. The electrolytic capacitor according to claim 5, wherein the aprotic polar solvent contains at least one selected from the group consisting of lactone compounds, cyclic sulfone compounds, and sulfoxide compounds.

7. The electrolytic capacitor according to claim 1,
wherein the liquid component does not contain a protic organic solvent or contains a protic organic solvent, and
when the liquid component contains the protic organic solvent, a concentration of the protic organic solvent in the liquid component is 20 mass % or less.

8. The electrolytic capacitor according to claim 1,
wherein the liquid component does not contain a solute or contains a solute, and
when the liquid component contains the solute, a concentration of the solute in the liquid component is 1 mass % or less.

9. The electrolytic capacitor according to claim 1,
wherein the conductive polymer component does not contain an additive that serves as an oxygen supply, or contains an additive that serves as an oxygen supply, and
when the conductive polymer component contains the additive, a content of the additive in the conductive polymer component is 0.1 mass % or less.

10. A manufacturing method of an electrolytic capacitor, comprising:
a step of preparing a capacitor element that includes an anode foil having a dielectric layer on a surface thereof, a cathode foil, and a separator and a conductive polymer component that are interposed between the anode foil and the cathode foil; and
a step of obtaining an electrolytic capacitor by housing in a case the capacitor element and a liquid component containing a non-aqueous solvent and having a water concentration of 1000 ppm or more and 10000 ppm or less by mass,
wherein the separator contains a synthetic resin fiber.

11. The manufacturing method of an electrolytic capacitor according to claim 10,
wherein in the step of preparing the capacitor element, the capacitor element is prepared by impregnating a precursor including the anode foil, the cathode foil, and the separator into a treatment liquid containing the conductive polymer component, and drying the precursor.

12. The manufacturing method of an electrolytic capacitor according to claim 11,
wherein the treatment liquid does not contain an additive that serves as an oxygen supply, or contains an additive that serves as an oxygen supply, and
when the treatment liquid contains the additive, a content of the additive in the treatment liquid is 15 mass % or less.
